(19) United States
(12) Patent Application Publication
(10) Pub. No.: US 2026/0331084 A1
(43) Pub. Date: Oct. 22, 2026

(54) ACTIVE-PASSIVE PICKUP MODE SWITCHING OUTPUT INTERFACE FOR ELECTRIC GUITAR

(71) Applicant: Qian Chen, Shenzhen (CN)

(72) Inventor: Qian Chen, Shenzhen (CN)

(21) Appl. No.: 19/698,911

(22) Filed: Jun. 5, 2026

(51) Int. Cl. G10H 1/34; G10H 3/18

(52) U.S. Cl. CPC G10H 1/34; G10H 3/181; G10H 3/186

(57) ABSTRACT

An active-passive pickup mode switching output interface for an electric guitar includes an integrated mounting panel. A front surface of the integrated mounting panel is provided with a switching mechanism. The switching mechanism includes a PCB circuit board, an audio output jack, an active-passive mode switch, a button cell, a boost circuit, an active signal processing circuit and a gain adjustment potentiometer. The PCB circuit board is fixedly connected to the front surface of the integrated mounting panel. The audio output jack is fixedly connected to a back surface of the integrated mounting panel. With the integrated mounting panel, the PCB circuit board, the audio output jack, the active-passive mode switch, the button cell, the boost circuit, the active signal processing circuit and the gain adjustment potentiometer can be integrated into a single structure, forming an integrated assembly, without additional wiring or drilling inside the guitar.

### TECHNICAL FIELD

The present disclosure relates to the technical field of electric guitar output interfaces, more particularly to an active-passive pickup mode switching output interface for an electric guitar.

### BACKGROUND

Electric guitar pickups are mainly divided into two types: passive pickups and active pickups, which differ significantly in timbre characteristics and operating principles. The passive pickups require no external power supply and generate audio signals as strings vibrate and cut through a magnetic field, delivering a warm, rich tone with natural dynamic response. However, they have a low output level and weak noise immunity, and are prone to noise and current hum during high-gain playing. The active pickups are inbuilt with an amplifier circuit and need to connect to an external power supply. They have a high output level, low noise, and a clear, tight tone. However, they lack the native dynamics and warm tonality of the passive pickups, resulting in relatively limited tonal expressiveness.

Conventionally, to achieve active-passive switching or active circuits on an electric guitar, a circuit board, a battery, a potentiometer, a switch and the like are dispersedly arranged inside a guitar cavity and connected by soldering multiple wires. This requires the operator to have advanced skills in electronic soldering and guitar circuit modification, and is time-consuming.

Therefore, an active-passive pickup mode switching output interface for an electric guitar is provided to address the above problems.

### SUMMARY

In view of the above shortcomings, the present disclosure provides an active-passive pickup mode switching output interface for an electric guitar to address the problem that, conventionally, to achieve active-passive switching or active circuits on an electric guitar, a circuit board, a battery, a potentiometer, a switch and the like are dispersedly arranged inside a guitar cavity and connected by soldering multiple wires, which requires the operator to have advanced skills in electronic soldering and guitar circuit modification and is time-consuming.

To achieve the above aim, the present disclosure provides the following technical solution. An active-passive pickup mode switching output interface for an electric guitar includes an integrated mounting panel. A front surface of the integrated mounting panel is provided with a switching mechanism and is formed with mounting holes.

The switching mechanism includes a PCB circuit board, an audio output jack, an active-passive mode switch, a button cell, a boost circuit, an active signal processing circuit and a gain adjustment potentiometer. The PCB circuit board is fixedly connected to the front surface of the integrated mounting panel. The audio output jack is fixedly connected to a back surface of the integrated mounting panel. The active-passive mode switch is fixedly connected to the back surface of the integrated mounting panel. The button cell is fixedly connected to a surface of the PCB circuit board. The boost circuit is fixedly connected to the surface of the PCB circuit board. The active signal processing circuit is fixedly connected to the surface of the PCB circuit board. The gain adjustment potentiometer is fixedly connected to the surface of the PCB circuit board.

Preferably, the audio output jack is configured to extend through the integrated mounting panel; and an extension end of the audio output jack is configured to electrically connect to the PCB circuit board.

Preferably, the active signal processing circuit is electrically connected to the PCB circuit board; and the gain adjustment potentiometer is electrically connected to the PCB circuit board.

Preferably, the button cell is electrically connected to the PCB circuit board; and the boost circuit is electrically connected to the PCB circuit board.

Preferably, an active-passive isolation and switching control circuit is electrically connected to the active-passive mode switch; and the boost circuit is electrically connected to the active signal processing circuit and the gain adjustment potentiometer.

Preferably, the active-passive mode switch is configured to control an input end of the audio output jack to switch between a passive pickup signal path and an active pickup signal path, through the active-passive isolation and switching control circuit.

Preferably, when switching to the active pickup signal path, the button cell is configured to supply power to the active signal processing circuit; and the gain adjustment potentiometer forms a gain adjustment network with the active signal processing circuit to adjust output signal amplitude in the active mode.

Compared to existing technologies, the active-passive pickup mode switching output interface for the electric guitar provided by the present disclosure offers the following beneficial effects.

First, with the integrated mounting panel, the PCB circuit board, the audio output jack, the active-passive mode switch, the button cell, the boost circuit, the active signal processing circuit and the gain adjustment potentiometer can be integrated into a single structure, forming an integrated assembly, without additional wiring or drilling inside the guitar.

Second, the active-passive isolation and switching control circuit and the active signal processing circuit are integrated on the PCB circuit board, achieving isolation and switching between active and passive signals, as well as signal amplification and gain adjustment in the active mode

### BRIEF DESCRIPTION OF THE DRAWINGS

FIG. 1 is an overall structural diagram of the present disclosure.

FIG. 2 is a structural diagram of a back surface of the present disclosure.

FIG. 3 is a first top view of the present disclosure.

FIG. 4 is a second top view of the present disclosure.

In the drawings: 1, integrated mounting panel; 2, switching mechanism; 21, PCB circuit board; 22, audio output jack; 23, active-passive mode switch; 24, button cell; 25, gain adjustment potentiometer; 26, boost circuit; and 27, active signal processing circuit.

### DETAILED DESCRIPTION OF THE EMBODIMENTS

A clear and complete description as below is provided for the technical solution in the embodiments of the present disclosure in conjunction with the drawings in the embodiments of the present disclosure. Obviously, the embodiments described hereinafter are merely part embodiments of the present disclosure, rather than all of the embodiments. All other embodiments obtained by the ordinary skill in the art based on the embodiments in the present disclosure without creative work are intended to be included in the scope of protection of the present disclosure.

### Embodiments

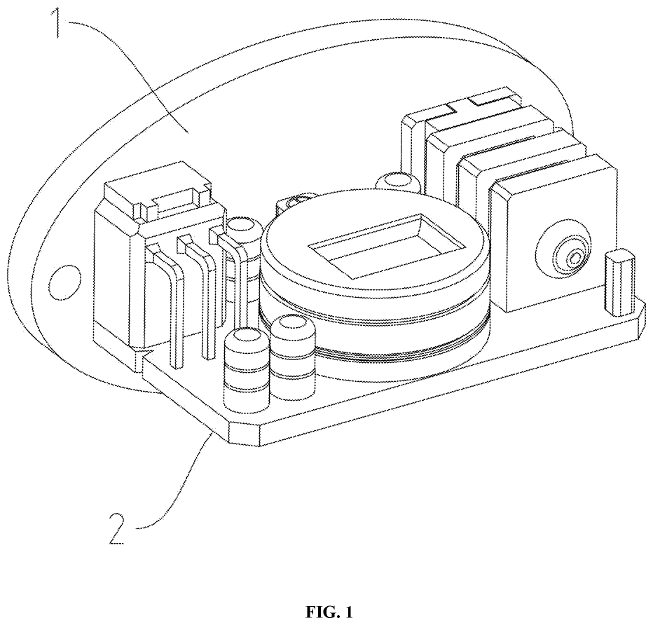

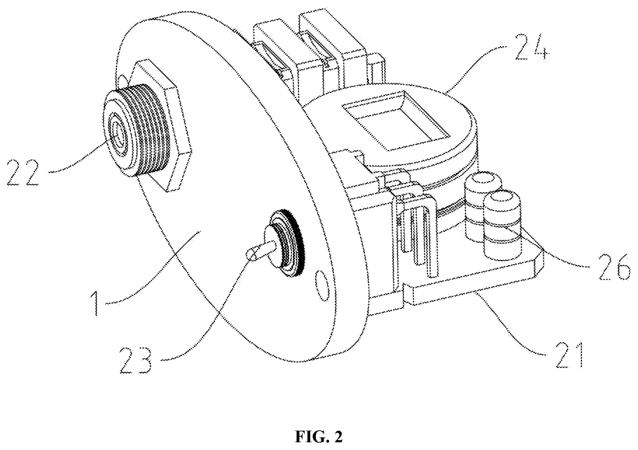

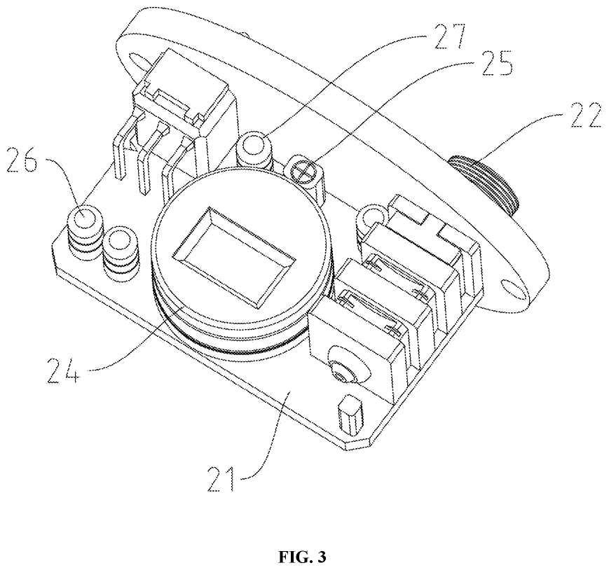

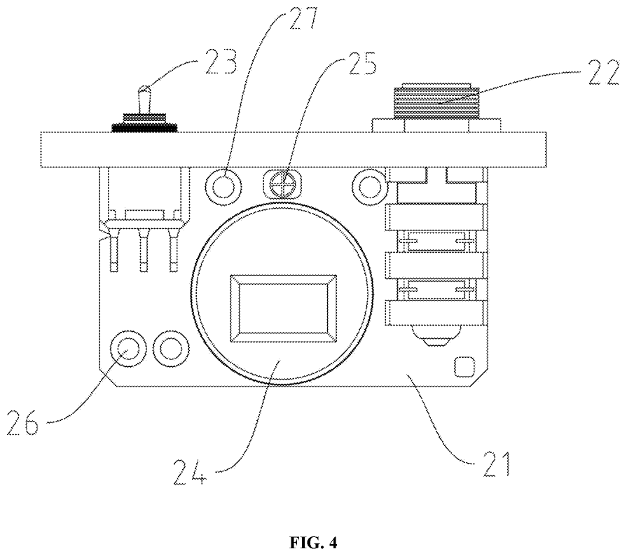

Referring to FIG. 1 to FIG. 4, the embodiments provide an active-passive pickup mode switching output interface for an electric guitar, including an integrated mounting panel 1. A front surface of the integrated mounting panel 1 is provided with a switching mechanism 2 and is formed with mounting holes.

The switching mechanism 2 includes a PCB circuit board 21, an audio output jack 22, an active-passive mode switch 23, a button cell 24, a gain adjustment potentiometer 25, an active signal processing circuit 27 and a boost circuit 26. The PCB circuit board 21 is fixedly connected to the front surface of the integrated mounting panel 1. The audio output jack 22 is fixedly connected to a back surface of the integrated mounting panel 1. The active-passive mode switch 23 is fixedly connected to the back surface of the integrated mounting panel 1. The button cell 24 is fixedly connected to a surface of the PCB circuit board 21. The boost circuit 26 is fixedly connected to the surface of the PCB circuit board 21. The gain adjustment potentiometer 25 is fixedly connected to the surface of the PCB circuit board 21. The active signal processing circuit 27 is fixedly connected to the surface of the PCB circuit board 21.

With the integrated mounting panel 1, the PCB circuit board 21, the audio output jack 22, the active-passive mode switch 23, the button cell 24, the gain adjustment potentiometer 25, the active signal processing circuit 27 and the boost circuit 26 can be integrated into one same structure, achieving a compact and modular active-passive switching output interface, which can be utilized to directly replace a conventional output interface of an electric guitar. The integrated mounting panel 1 serves as a structural base plate. Its front surface is fixed with the PCB circuit board 21, the button cell 24, the gain adjustment potentiometer 25, the active signal processing circuit 27 and the boost circuit 26. Its back surface is fixed with the audio output jack 22 and the active-passive mode switch 23. In this way, all parts form an integrated assembly through the panel.

The audio output jack 22 is configured to extend through the integrated mounting panel 1; and an extension end of the audio output jack 22 is configured to electrically connect to the PCB circuit board 21.

Such configuration can achieve both mechanical fixation and electrical signal transmission of the audio output jack 22, ensuring a reliable connection between the audio output jack 22 and the PCB circuit board 21. The audio output jack 22 extends through the integrated mounting panel 1 and its extension end is electrically connected to the PCB circuit board 21 directly, thereby allowing signals from a pickup or signals actively processed to output to an external speaker through the jack.

The gain adjustment potentiometer 25 is electrically connected to the PCB circuit board 21; the button cell 24 is electrically connected to the PCB circuit board 21; the active signal processing circuit 27 is electrically connected to the PCB circuit board 21; and the boost circuit 26 is electrically connected to the PCB circuit board 21. Such configuration provides physical basis for signal adjustment, power supply and filtering in the active mode. The gain adjustment potentiometer 25 and the active signal processing circuit 27 are configured to adjust gain. The button cell 24 and the boost circuit 26 are configured to provide a power supply for the active mode.

An active-passive isolation and switching control circuit is electrically connected to the active-passive mode switch 23; and the active signal processing circuit 27 is electrically connected to the gain adjustment potentiometer 25. The active-passive mode switch 23 is electrically connected to the active-passive isolation and switching control circuit to transmit a switching command. The boost circuit 26 is electrically connected to the gain adjustment potentiometer 25 and the active signal processing circuit 27 to participate in gain adjustment.

The active-passive mode switch 23 is configured to control an input end of the audio output jack 22 to switch between a passive pickup signal path and an active pickup signal path, through the active-passive isolation and switching control circuit. The active-passive mode switch 23 sends a switching command; and the active-passive isolation and switching control circuit controls, based on the switching command, the input end of the audio output jack 22 to switch between the direct passive pickup signal path and the active pickup signal path via the active signal processing circuit 27.

When switching to the active pickup signal path, the button cell 24 is configured to supply power to the active signal processing circuit 27; and the active signal processing circuit 27 forms a gain adjustment network with the gain adjustment potentiometer 25 to adjust output signal amplitude in the active mode by changing feedback depth or filtering characteristics.

The operating principle of the above embodiment is as follows. When a user fixes the integrated mounting panel 1 at an original output interface position of an electric guitar, he/she can toggle the active-passive mode switch 23 to issue a mode selection command. The active-passive isolation and switching control circuit on the PCB circuit board 21 recognizes the command, and controls, based on the command, the input end of the audio output jack 22 to switch between the passive pickup signal path and the active pickup signal path. When switching to the passive mode, the pickup signals are directly output to the external speaker through the audio output jack 22. At this time, the button cell 24, the gain adjustment potentiometer 25 and the active signal processing circuit 27 do not work, achieving passive output without power supply. When switching to the active mode, the button cell 24 supplies power to the active signal processing circuit 27 on the PCB circuit board 21, and the pickup signals first enter the active signal processing circuit and then enter the gain adjustment network formed by the gain adjustment potentiometer 25 and the active signal processing circuit 27. The user can rotate the gain adjustment potentiometer 25 to change the feedback depth or filtering characteristics of the gain adjustment network, thereby adjusting output signal amplitude. The final signal is output to the external speaker through the audio output jack 22. Such configuration can achieve one-key switching between active and passive modes and a gain adjustment function in the active mode.

The mounting modes, connection modes or arrangement modes provided in the present embodiment are all common mechanical connection modes, and any mode capable of achieving the intended beneficial effects may be implemented. Therefore, detailed descriptions of the specific structural composition and operating principle are omitted herein.

Although the embodiments of the present disclosure have been illustrated and described above, it is understandable for the ordinary skill in the art that various changes, modifications, substitutions and alternations can be made to these embodiments without departing from the spirit and principle of the present disclosure. The scope covered by the present disclosure is defined by the claims appended hereinafter and equivalents thereof.

What is claimed is:

1. An active-passive pickup mode switching output interface for an electric guitar, comprising an integrated mounting panel (1), wherein a front surface of the integrated mounting panel (1) is provided with a switching mechanism (2) and is formed with mounting holes; and wherein
the switching mechanism (2) comprises a PCB circuit board (21), an audio output jack (22), an active-passive mode switch (23), a button cell (24), an active signal processing circuit (27), a gain adjustment potentiometer (25) and a boost circuit (26), the PCB circuit board (21) being fixedly connected to the front surface of the integrated mounting panel (1), the audio output jack (22) being fixedly connected to a back surface of the integrated mounting panel (1), the active-passive mode switch (23) being fixedly connected to the back surface of the integrated mounting panel (1), the button cell (24) being fixedly connected to a surface of the PCB circuit board (21), the boost circuit (26) being fixedly connected to the surface of the PCB circuit board (21), the active signal processing circuit (27) being fixedly connected to the surface of the PCB circuit board (21), and the gain adjustment potentiometer (25) being fixedly connected to the surface of the PCB circuit board (21).

2. The active-passive pickup mode switching output interface for the electric guitar according to claim 1, wherein the audio output jack (22) is configured to extend through the integrated mounting panel (1), an extension end of the audio output jack (22) being configured to electrically connect to the PCB circuit board (21).

3. The active-passive pickup mode switching output interface for the electric guitar according to claim 2, wherein the active signal processing circuit (27) is electrically connected to the PCB circuit board (21), and wherein the gain adjustment potentiometer (25) is electrically connected to the PCB circuit board (21).

4. The active-passive pickup mode switching output interface for the electric guitar according to claim 3, wherein the button cell (24) is electrically connected to the PCB circuit board (21), and wherein the boost circuit (26) is electrically connected to the PCB circuit board (21).

5. The active-passive pickup mode switching output interface for the electric guitar according to claim 4, wherein an active-passive isolation and switching control circuit is electrically connected to the active-passive mode switch (23); wherein the active signal processing circuit (27) is electrically connected to the gain adjustment potentiometer (25); and wherein the button cell (24) is electrically connected to the boost circuit (26).

6. The active-passive pickup mode switching output interface for the electric guitar according to claim 5, wherein the active-passive mode switch (23) is configured to control an input end of the audio output jack (22) to switch between a passive pickup signal path and an active pickup signal path, through the active-passive isolation and switching control circuit.

7. The active-passive pickup mode switching output interface for the electric guitar according to claim 6, wherein when switching to the active pickup signal path, the button cell (24) is configured to supply power to the active signal processing circuit (27), and wherein the active signal processing circuit (27) forms a gain adjustment network with the gain adjustment potentiometer (25) to adjust output signal amplitude in the active mode.
